(19) United States
(12) Patent Application Publication
(10) Pub. No.: US 2023/0175099 A1
(43) Pub. Date: Jun. 8, 2023

(54) LI-ION BATTERY RECYCLING PROCESS AND SYSTEM FOR BLACK MASS FRACTIONATION AND RECOVERY OF SPECIFIC MATERIALS

(71) Applicant: Comstock IP Holdings LLC, Milton, GA (US)

(72) Inventors: Rahul Bobbili, San Jose, CA (US); Michael J. RIEBEL, Mankato, MN (US); David WINSNESS, Alpharetta, GA (US); Milton J. RIEBEL, Mankato, MN (US)

(21) Appl. No.: 18/054,434

(22) Filed: Nov. 10, 2022

Related U.S. Application Data
(60) Provisional application No. 63/277,961, filed on Nov. 10, 2021.

(51) Int. Cl. C22B 26/12; H01M 10/54; C22B 7/00; C22B 4/02; C22B 1/24; C22B 1/02

(52) U.S. Cl. CPC C22B 26/12; H01M 10/54; C22B 7/001; C22B 4/02; C22B 7/006; C22B 1/24; C22B 1/02; H01M 10/0525

(57) ABSTRACT

A method is provided for recycling lithium-ion batteries containing plastics, electrolyte, carbon, metals, and lithium. The method includes: Lithium-ion batteries are ground to form ground battery material which is then pyrolyzed at a temperature between about 100° C. and 700° C. for a time sufficient to vaporize about 80 wt % to 100 wt % of electrolytes present in the ground battery material. The resulting material is further ground and screen classified to produce a screen oversize and a screen undersize. The screen oversize comprises metals and plastics, while the screen undersize comprises a black mass material. Lithium dissolution, triboelectric charging and electrostatic separation of the black mass material (not necessarily in that order) produces a liquid comprising dissolved lithium, a graphite product, and a concentrated metal fines product. Lithium is precipitated from the liquid comprising dissolved lithium, and the concentrated metal fines can be further treated by hydrometallurgy or pyrometallurgy processes.

### INCORPORATION BY REFERENCE STATEMENT

This application claims priority to U.S. Provisional Application 63/277,961 filed Nov. 10, 2021, the entire contents of which are hereby expressly incorporated herein by reference.

### BACKGROUND OF THE DISCLOSURE

For decades, portable electrical power supplies have taken the form of batteries that release electrical energy from an electrochemical reaction. Various battery chemistries, such as traditional “dry cell” carbon flashlight batteries, and lead acid “wet” cells common in automobiles have provided adequate portable electrical power.

Advances in lithium-ion batteries (LIBs) have been significant such that they have become the most popular power source for portable electronics equipment, and are also growing in popularity for military, electric vehicle, and aerospace applications. Continuing development of personnel electronics, hybrid and electric vehicles, ensures that Li-ion batteries will continue to be increasingly in demand. But with the growing demand and advances in lithium-ion batteries, there is now concern over the “end of life” issues and the inability to safely and efficiently recycle the valuable materials within the batteries.

Lithium-Ion batteries contain valued elements such as cobalt (Co), nickel (Ni), manganese (Mn), and lithium (Li). Lithium-Ion batteries also include materials used in their packaging such as various plastics and metals for their protective casing. In addition, lithium-ion battery anodes contain a very high percentage of graphite or carbon.

Lithium-ion batteries (LIBs), like their NiCd (nickel-cadmium) and NiMH (nickel-metal hydride) predecessors, have a finite number of charge cycles. It is therefore expected that LIBs will become a significant component of the solid waste stream, as numerous electric vehicles reach the end of their lifespan. The ability to process and store LIBs at their end of life, and to separate specific valued elements to be processed back into new batteries, is critical as the world becomes more dependent on mobile electrical applications. While various attempts have been made to recycle lithium batteries back into their individual elements, there is a need for more efficient overall process. There is also a need for processes that can reduce the amount of graphite from the black mass.

### SUMMARY OF THE INVENTIVE CONCEPTS

A method is provided for recycling lithium-ion batteries containing plastics, electrolyte, carbon, metals, and lithium. In one embodiment, the method includes the following steps: Lithium-ion batteries are ground to form ground battery material which is then pyrolyzed at a temperature between about 100° C. and 700° C. for a time sufficient to vaporize about 80 wt % to 100 wt % of electrolyte present in the ground battery material. The resulting material is further ground and screen classified to produce a screen oversize and a screen undersize. The screen oversize comprises metals and plastics, while the screen undersize comprises a black mass material. Lithium dissolution, triboelectric charging and electrostatic separation of the black mass material (not necessarily in that order) produces a liquid comprising dissolved lithium, a graphite product, and a metal fines product. Lithium is precipitated from the liquid comprising dissolved lithium.

In one embodiment, the black mass material is first separated using triboelectric charging and electrostatic separation to produce a carbon (graphite) product and a grey mass comprising lithium and metal fines. The lithium is dissolved from the grey mass leaving a solid residue comprising the metal fines and a liquid comprising dissolved lithium. Dissolved lithium is then precipitated and recovered from the liquid.

In one embodiment, lithium is first dissolved from the black mass material to produce a lithium-depleted back mass and a liquid containing dissolved lithium. The lithium-depleted black mass is dried and then separated by triboelectric charging and electrostatic separation to produce a graphite product and a concentrated metal fines product. Dissolved lithium is precipitated and recovered from the liquid.

In one embodiment, electrostatic separation is accomplished using a belt separator system. Graphite within the separated black mass, or within the lithium-depleted black mass, can be removed or reduced by means of a triboelectric charging and electrostatic belt separator system to produce graphite product. Separation of the graphite using a dry separation process retains its performance and potential for recycling into batteries or in other graphite applications.

In one embodiment, supercritical fractionation and/or acid processing of the black mass is used to dissolve lithium. In another embodiment, supercritical fractionation and/or acid processing of the gray mass is used to dissolve lithium for example, supercritical water or supercritical CO₂ can be used to dissolve the lithium. In one embodiment, after solid/liquid separation, the lithium can be precipitated from the liquid by evaporation.

The remaining powder stream comprising primarily concentrated powder metals can be treated hydrometallurgically or pyrometallurgically processing with improved efficiencies and lower power requirements.

### BRIEF DESCRIPTION OF THE DRAWINGS

The accompanying drawings, which are incorporated in and constitute a part of this specification, illustrate one or more implementations described herein and, together with the description, explain these implementations. The drawings are not intended to be drawn to scale, and certain features and certain views of the figures may be shown exaggerated, to scale or in schematic in the interest of clarity and conciseness. Not every component may be labeled in every drawing. Like reference numerals in the figures may represent and refer to the same or similar element or function. In the drawings:

FIG. 1 illustrates an overall process flow embodiment as presently disclosed and claimed.

FIG. 2 illustrates example triboelectric charging and electrostatic separation process steps as presently disclosed and claimed.

FIG. 3 illustrates another overall process flow embodiment as presently disclosed and claimed.

### DETAILED DESCRIPTION OF EXEMPLARY EMBODIMENTS

Before explaining at least one embodiment of the presently disclosed inventive concept(s) in detail, it is to be understood that the presently disclosed inventive concept(s) is not limited in its application to the details of construction and the arrangement of the components or steps or methodologies set forth in the following description or illustrated in the drawings. The presently disclosed inventive concept(s) is capable of other embodiments or of being practiced or carried out in various ways. Also, it is to be understood that the phraseology and terminology employed herein is for the purpose of description and should not be regarded as limiting.

While the following terms are believed to be well understood by one of ordinary skill in the art, the following definitions are set forth to facilitate explanation of the presently disclosed subject matter.

Following long-standing patent law convention, the terms “a”, “an”, and “the” refer to “one or more” when used in this application, including the claims. Thus, for example, reference to “lithium battery elements” includes a plurality or mixture of lithium, cobalt, nickel, plastics, materials and so forth.

Unless otherwise indicated, all numbers expressing quantities of size (e.g., length, width, diameter, thickness), volume, mass, force, strain, stress, time, temperature or other conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

The use of the term “or” in the claims is used to mean “and/or” unless explicitly indicated to refer to alternatives only or the alternatives are mutually exclusive, although the disclosure supports a definition that refers to only alternatives and “and/or.” As used herein “another” can mean at least a second or more.

As used herein, the term “and/or” when used in the context of a listing of entities, refers to the entities being present singly or in combination. Thus, for example, the phrase “A, B, C, and/or D” includes A, B, C, and D individually, but also includes any and all combinations and sub combinations of A, B, C, and D.

The term “comprising”, which is synonymous with “including,” “containing,” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

As used herein, the term “substantially” means that the subsequently described event or circumstance completely occurs or that the subsequently described event or circumstance occurs to a great extent or degree. For example, when associated with a particular event or circumstance, the term “substantially” means that the subsequently described event or circumstance occurs at least 80% of the time, or at least 85% of the time, or at least 90% of the time, or at least 95% of the time. The term “substantially adjacent” may mean that two items are 100% adjacent to one another, or that the two items are within close proximity to one another but not 100% adjacent to one another, or that a portion of one of the two items is not 100% adjacent to the other item but is within close proximity to the other item

Much of the prior art focuses on starting with already processed black mass materials. Black mass includes the materials used to produce the anode and cathode of the battery typically comprising powders of graphite, cobalt, nickel, lithium, aluminum and other materials depending on the type of the lithium containing battery. Black mass is typically a very fine powder material in which graphite is the primary material within this fraction. Graphite can represent approximately 50% of the total black mass weight and given its low bulk density can be much more than 50% of the volume. Thus, this high carbon or graphite content is partly responsible for the difficulties and higher energy inputs required for processing and separation. Much of the prior art has focused on treating this black mass. For example, in U.S. Pat. No. 10,522,884, Method and apparatus for recycling lithium-ion batteries, Yan Wang focuses on separating the basic materials from ground black mass material. This art speaks of using “discharged batteries” and crushed batteries and does not address the means or process to crush or otherwise create the black mass material. This art uses high amounts of a strong acidic leaching agent and addition of hydrogen peroxide to dissolve and then separate the materials from un-dissolved materials. This is problematic in dealing with the large quantities of strong acid and peroxides required to dissolve the cathode material. In addition, the process of discharging individual batteries is labor and time intensive.

U.S. Pat. No. 9,825,341, Recycling positive-electrode material of a lithium-ion battery, to Steven Sloop, discloses methods for recycling positive-electrode material from lithium-ion batteries using heat, pressure, and large volumes of hydroxide solution. Again, this art starts with the already processed black mass and states that the starting battery can be simply drilled or cut without providing a good solution for creating the starting black mass material. More so, Sloop requires a supercritical step to remove electrolyte, but does not teach fractionation or removal of any other materials.

Much of the prior art focuses on starting with already processed black mass materials and does not teach methods for discharging or safely processing the batteries to convert into the remaining black mass material from the LIB. LIBs typically do not lose all their charge at the end of life, and some lithium batteries to be recycled may have a partial to full charge. However, major technical hurdles are presented in the discharging, crushing, separation and processing of the lithium battery to create a black mass starting material. Lithium-ion batteries are not supposed to be put in conventional waste streams or landfills. LIBs, if punctured or crushed, can leak or short-circuit, which can cause a fire or toxic gas release. Thus, much of the prior art.

Discharging the lithium-ion battery prior to recycling also has limitations. Publications and patents relating to using a liquid electrolyte in which the batteries are submerged have been evaluated. For example, “Aqueous solution discharge of cylindrical lithium-ion cells” uses various phosphates with water to discharge the battery. This creates numerous issues including water electrolysis creating flammable hydrogen and various leakage into the water solution which requires extensive processing to reclaim and purify the water.

U.S. Pat. No. 10,960,403—Process, apparatus, and system for recovering materials from batteries, Ajay Kochhar teaches of a process to recover materials from lithium-ion batteries by first submerging the battery in an immersion liquid creating reduced-size battery materials and liberating the electrolyte material and a black mass material comprising anode and cathode powders. This art requires that the batteries are then submerged in a high concentration of an aqueous electrolyte solution first creating the same problems of dealing with high percentages of dangerous chlorides, hydroxides within the aqueous electrolyte. Within this liquid chemistry they provide for an option to remove graphite, but requires being in a liquid admixture during the hydrometallurgical process.

There are many factors that have formed barriers to widespread recycling of Li-ion batteries. These factors include technical hurdles, future uncertainty, and economic viability. First, Li-ion batteries are complex, integrally formed objects, with a large number of different materials assembled in such a way that prevents simple separation of the components. Therefore, innovative solutions to facilitate deconstruction and recycling of these batteries are needed. Secondly, current processing of black mass has significant limitations and problems typically relating to the high loading of carbon graphite.

Black mass is typically processed wherein it goes directly to pyrometallurgical processes in which the graphite is simply burned off providing no recycle valued. This is problematic given these high temperatures also can burn off a portion or all the lithium fraction. Secondly this common process only focuses on the recycling of the key valued metals such as cobalt and nickel. New forms of hydrometallurgical processes also take the black mass material and dissolves each of the metals and precipitates it out for collection. In this process, typically the lithium is removed last and graphite is problematic given it typically is approximately 50% of the total black mass by weight and significantly more by volume given its very low bulk density.

Various attempts have been made to first separate the black mass. For example, U.S. Pat. No. 9,156,038 to Ellis discloses processing lithium-ion batteries to obtain a fine material and mix with a carrier fluid to form a slurry. Then the slurry is subjected to a paramagnetic field of very high intensity in an attempt to pull out the metal on the magnet. This present numerous limitations for metal recovery and also requires a slurry or carrier fluid that must be removed after separation.

The present disclosure generally relates to methods of recycling lithium-ion batteries including triboelectric charging/electrostatic separation of black mass to remove carbon or graphite (used interchangeably herein) to produce a “grey mass,” and further processing of grey mass for lithium and other metal recover with improved efficiencies, throughput, measurement accuracy, quality and lower energy inputs.

Lithium-Ion batteries are composed of metals including lithium, manganese, cobalt, and nickel in addition to high percentages of graphite and carbon. Once the battery reaches the end of its useful life, the batteries can be shredded in various processes.

This disclosure integrates a new dry preprocessing process for processing various lithium-based batteries and electronics scrap using a multi-chamber system further comprising a nitrogen, CO₂ or inert gas environment, also invented by the same inventors of this application.

This system further provides for a process to produce black mass from end-of-life lithium containing batteries which shreds the batteries in an inert gas, such as but not limited to nitrogen, flow atmosphere and depolymerize the electrolyte fraction of the battery by pyrolysis, then the separation of the black mass material herein incorporated by reference in its entirety.

Although the inert gas flow multi-chamber system is the embodiment primarily discussed, other means to shred lithium-ion batteries and screen out the black mass material are included within this disclosure.

The shredded, pyrolysis process and screened fine material is then processed to produce so-called “black mass”, which consists of high levels and various amounts of lithium, manganese, cobalt, nickel metals and graphite/carbon. In order to recycle black mass back into new batteries these materials require fractionation of the black mass into separate materials of high purity and quality through separation. The ability to recycle these metals and “close the loop” on their life cycle will directly impact the need for virgin materials while simultaneously reducing the carbon footprint required for new mining activities. As a result, environmentally sustainable and economically viable recycling is an essential need as the need for lithium-ion batteries.

With the growth of lithium-ion batteries in electronic devices, power tools and automotive applications, it is critical that new safe and efficient recycling methods are developed and instituted. Recycling of lithium-ion batteries provides for several benefits. First, it reduces the quantities of minerals needed to be mined, as well as the number of ores needed to be processed, which further in turn reduces NOx and SOx produced through these processes. Recycling of lithium-ion batteries also leads to the reduction of landfilling or unsafe storage of lithium batteries preventing potential damage or puncturing that can lead to fires that can potentially release contaminants and toxic gases into the atmosphere due to burning.

Recycling can dramatically reduce the required lithium amount required for the growth of this industry. Additionally, battery disposal would require that fresh metals be mined for cathode material, and mining has a much bigger environmental impact and cost than simple recycling would. In short, recycling of lithium-ion batteries not only protects the environment and saves energy, but also presents a lucrative outlet for battery manufacturers by providing an inexpensive supply of active cathode material for new batteries.

The “end-of-life” or “out-of-spec” lithium-ion batteries provides for various challenges in recycling including the issue that the lithium batteries have a multitude of different materials and metals within. The shredding, pyrolysis and screening first separates out the aluminum, copper and plastics separately from the powder black mass stream.

As noted in further detail below, rechargeable lithium-ion batteries comprise a number of different materials. “Black mass” is known to be a component of rechargeable lithium-ion batteries, which comprises a combination of cathode and/or anode electrode powders comprising lithium metal oxides and lithium iron phosphate (cathode) and graphite (anode). Materials present in rechargeable lithium-ion batteries include organics such as alkyl carbonates (e.g., C1-C6 alkyl carbonates, such as ethylene carbonate (EC), ethyl methyl carbonate (EMC), dimethyl carbonate (DMC), diethyl carbonate (DEC), propylene carbonate (PC), and mixtures thereof), iron, aluminum, copper, plastics, graphite, cobalt, nickel, manganese, and of course lithium.

The disclosure herein takes the powder black mass and fractionates it into three main portions: graphite, lithium carbonate, and a highly concentrated metal fraction.

Graphite removal phase—Within the black mass material there can be a range of percentages of graphite or carbon that primarily comes from the anode portion of a lithium containing battery. Within the black mass graphite or carbon content can represent approximately 50% of the total weight of the black mass by weight. Given graphite or carbons lower bulk density than the other metals contained within the black mass, the volume of the graphite or carbon can be significantly more than 50%.

Graphite or carbon are problematic in various separation and measurement processes. In conventional pyrometallurgical processes, the carbon is burnt off prior to separation of the cobalt, nickel and other valued metals. Thus, this requires more energy, higher volume throughput and the graphite obviously cannot be recycled, or its value captured. Secondly carbon or graphite is very problematic in measuring the exact amount of the valued metals using standard test methods such as ICP or other spectrometer equipment. ICP requires that all material be dissolved in a high concentration of sulfuric acid or similar strong acid. In this case not all of the carbon can be dissolved or a portion of the carbon goes up in gaseous form thus effecting the final weight calculations. The removal and reclamation of the graphite/carbon will help in both measurement techniques and provide for additional value stream within this process.

The disclosure first takes the black mass stream and runs through an electrostatic belt system to pull out the graphite or carbon. An electrostatic belt has the ability to operate continuously, works with dry materials and is a low energy consumption system. This portion of the disclosure utilizes between 1-4 Kahr per ton of feed processed that is significantly less than wet separation and drying. In other art, graphite or carbon has been attempted to be removed using water to separate the graphite by specific gravity. This is difficult given the fine particles of the black mass that requires skimming and drying processes that provides additional limitations. By using electrostatic separation to first pull out a high portion of the graphite/carbon in a dry state, the disclosure solves this limitation.

Within the disclosure the preferred embodiment is triboelectric charging and electrostatic separation that provides the processing a means to beneficiate fine materials with an entirely dry technology. Unlike other electrostatic separation processes that are typically limited to particles greater than 75 am in size, a triboelectric belt separator is ideally suited for separation of very fine (<1 μm) to moderately coarse (300 μm) materials with very high throughputs. The highly efficient process is effective on fine materials that cannot be separated at all by the conventional electrostatic techniques. Black mass particle sizes are a fine powder typically under the 75-micron ranges.

After triboelectric charging and electrostatic separation process, the resulting separation of graphite/carbon now provides a higher concentration of the metal powder fraction that is more accurately tested and assists in the next phase of this process.

The resulting material after graphite/carbon fractionation and separation is now called “grey mass” comprising primarily powder metals.

Measurement Process—The measurement of the individual components in black mass is complex and provides various problems given its unique and complex blend of materials. Black mass comprises various valued metals such as cobalt, aluminum, nickel, manganese and lithium. In addition, the primary material in black mass is graphite and/or carbon material. For battery recycling it is important to fully understand the accurate percentages of each of these elements as we move through the process, to sell the final concentrated metal mass or as we optimize various processes within this disclosure.

ICP is a common process for the testing of small percentages of metal impurities in water. ICP requires that all elements are dissolved in a liquid sample for the ICP process to accurately evaluate the material. Black mass is a complex mixture of various materials including large percentages of carbon or graphite that can easily represent 50% of the total black mass by weight. ICP processes typically use a very strong acid such as sulfuric acid to dissolve all materials into a liquid state for testing.

It is very difficult to dissolve the carbon or graphite material. Although possible, the usage of strong acids with various carbon materials can convert the carbon to a gaseous form that can affect the accuracy in the final weights due to this initial loss of material. Secondly, ICP cannot read carbon or its percentage due to its limitations of this test method and equipment.

The removal of a significant portion of the carbon or graphite greatly improves this process and minimizes inaccurate testing results. The disclosure herein teaches of a dry method that does not use liquids nor acids to remove a substantial portion of the carbon or graphite. Thus, ICP and other spectrometer testing methods are simply more accurate to the remaining valued metal fractions within materials at various stages within this process and providing the potential to certify concentrated metal mass and other fractionated output streams for their true element percentages, values and if any impurities still exist in these streams.

Extraction of Lithium—In other art using pyrometallurgical processes, the lithium typically comes out last in the process and is subject to potential impurities and changing of the lithium material. In one embodiment, we take the concentrated metal powders from the triboelectric charging/electrostatic separation process and blend this material with water. The ratio of water to metal powder may range between 1-99 part to 99-1 part and more preferably between (80-20 and 60-40). This may change based on the various percentages of specific metal powders, residual graphite percentage and amount of lithium we would extract. The liquid admixture of metal powder and water can then be injected into a supercritical continuous reactor pipe with the addition of CO₂ and optional acids. At supercritical state, the CO₂ acts like an acid that allows the dissolution of lithium metals into the water phase.

Supercritical carbon dioxide (sCO2) is a fluid state of carbon dioxide where it is held at or above its critical temperature and critical pressure. Carbon dioxide usually behaves as a gas in air at standard temperature and pressure (STP), or as a solid called dry ice when cooled and/or pressurized sufficiently. If the temperature and pressure are both increased from STP to be at or above the critical point for carbon dioxide, it can adopt properties midway between a gas and a liquid. More specifically, it behaves as a supercritical fluid above its critical temperature (304.13° K, 31.0° C., 87.8° F.) and critical pressure (7.3773 MPa, 72.8 atm, 1,070 psi, 73.8 bar), expanding to fill its container like a gas but with a density like that of a liquid.

In this disclosure, subcritical or supercritical CO₂ is an important tool for lithium extraction, partly because of its relatively low toxicity and environmental impact. The relatively low temperature of the process and the stability of CO₂ also allows most compounds to be extracted with little damage or inducing impurities. In addition, the solubility of many extracted compounds in CO₂ varies with pressure, permitting selective extractions. The pH is carefully controlled under either sub or super critical conditions. Typically, within supercritical conditions, the CO₂ provides sufficient pH levels to dissolve the lithium-based material. Within subcritical conditions, a secondary optional acid maybe required to obtain the sufficient pH levels to dissolve the lithium-based material.

After the material leaves the subcritical or supercritical process, the admixture is then separated into a liquid fraction and a solid fraction. The liquid fraction comprises the dissolved lithium metal and water. The water is evaporated by standard means to evaporate water such as simply boiling, multi-effect evaporators, and other standard equipment. As the water is removed, the lithium fraction precipitates into a fine crystalline form of lithium carbonate of a high quality and purity. By processing the “lithium first,” we maintain a high degree of purity and un-adulterated form of lithium that can be recycled back into lithium containing batteries.

In most lithium-ion batteries, the percentage of lithium within the black mass can range from 1-10% and more commonly approximately 4-7%. Within this disclosure we now have the ability to fractionate and extract a high percentage of the pure lithium carbonate for recycling.

The remaining concentrated metal powder is now even further concentrated and can be further separated using standard pyrometallurgical or hydrometallurgical processes being more efficient and using less energy due to the high concentration of metals and the removal of the main component of graphite/carbon from the material first. The remaining highly concentrated metal powder mass is sometimes referred to as a concentrated metal mass.

Through the process of this disclosure, we have now created a lower energy, lower emission, higher efficiency process to fractionate the primary materials of the lithium-ion batteries to help facilitate the recycling of these precious materials.

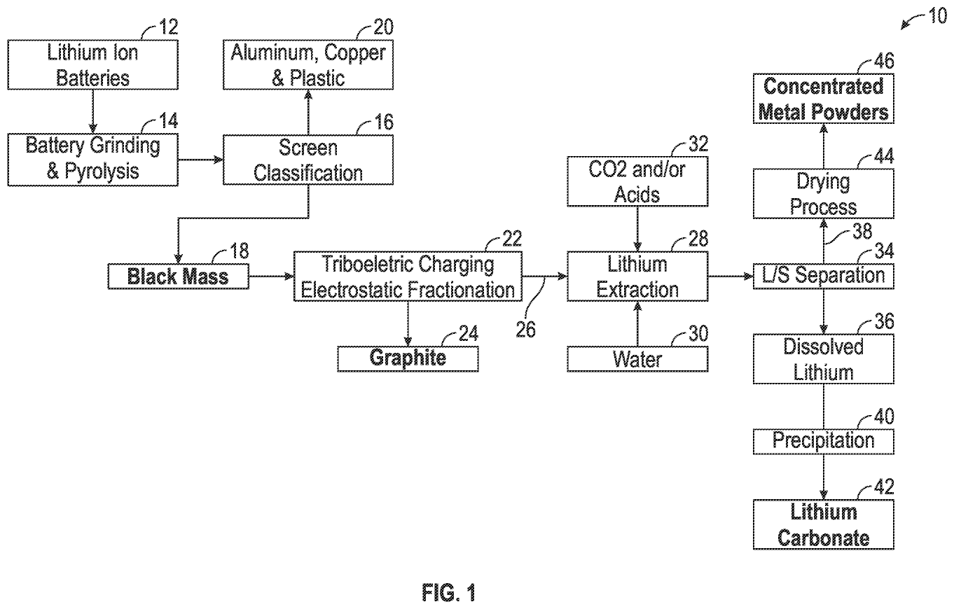

Referring now to FIG. 1, an embodiment of an overall lithium-ion battery recycling process 10 is illustrated. Lithium-containing batteries 12 are first processed using a shredder pyrolysis system 14 that is all under a nitrogen, or other inert gas such as, but not limited to, carbon dioxide. The inert gas flows constantly through the shredder and continuous pyrolysis system 14. The temperature of pyrolysis ranges from 100° C. to 700° C., 110° C. to 500° C., or 120° C. to 550° C. to disable or vaporize the electrolyte fraction of the shredded battery.

After pyrolysis, the shredded mass the undergoes screen classification 16 to be separated into a fine fraction 18 and course fractions 20. This can be done by various standard means of mechanical or air separation including simple screening. The course fractions 20 typically comprise aluminum, copper, plastics and various metals. The fine fraction 16 comprises black mass. Aluminum, copper and plastics are typically then sorted by means of air classification, eddy current separation, drum electrostatic separation or combinations thereof (not shown). Black mass 16 typically comprises various valued metals and graphite/carbon materials.

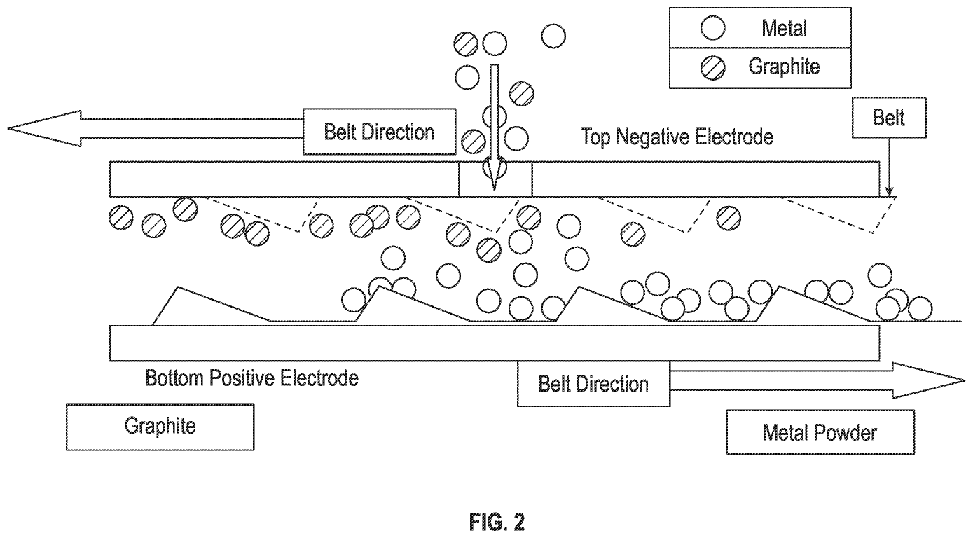

In one embodiment, the black mass 18 is then treated with triboelectric charging and electrostatic fractionation 22. This is shown in more detail in FIG. 2. Triboelectric charging is typically done by charging the incoming black mass particles and depositing them on a double belt press with various charges. The belts run in opposing directions (see FIG. 2). The differences in belt charges draw the graphite/carbon to one belt and the metal fraction to the other. This provides a graphite/carbon output 24 and a grey mass material 26 with a higher concentration of the powdered metals. The graphite and carbon materials 24 can then either be recycled or used in other graphite/carbon applications.

The grey mass material 26 can then be processed using subcritical and/or supercritical CO₂ extraction 28. This step can be done in batch processing or in a continuous pipe reactor. Water 30 and CO₂ 32 with an optional acid is blended with the grey mass 26 at a ratio of approximately 10:1 to create a free-flowing liquid. This ratio can change based on the types of black or grey mass and the pump style of the supercritical process. Given that we reduced the volume of the black mass significantly in the previous step 22, we see a more efficient, lower energy process. Secondly, this provides for additional “space” within the reactor vessel due to the removal of low bulk density carbon materials that provides for additional CO₂ level additions. This process dissolves and reacts the lithium with CO₂ to produce lithium carbonate. Careful control of pH is provided within this process step wherein pH at specific temperatures and pressures is sufficient to dissolve a substantial percentage of the lithium-based material or lithium carbonate into the water.

Separation of the aqueous lithium liquid 36 and the remaining solids 38 can be accomplished in a liquid/solid separation step 34. This step can be accomplished by various methods including, but not limited to, decanting, centrifugal separation, or various means of filtering. The liquid fraction 36 comprising dissolved lithium is sent to a precipitation step 40.

Lithium carbonate 42 can be precipitated by, for example, the removal of water. This can be done by various methods including basic evaporation steps. During evaporation the lithium precipitates in the water and can be removed separately for recycling back into lithium containing batteries. The final lithium-based product is then dried and in its final form for reuse.

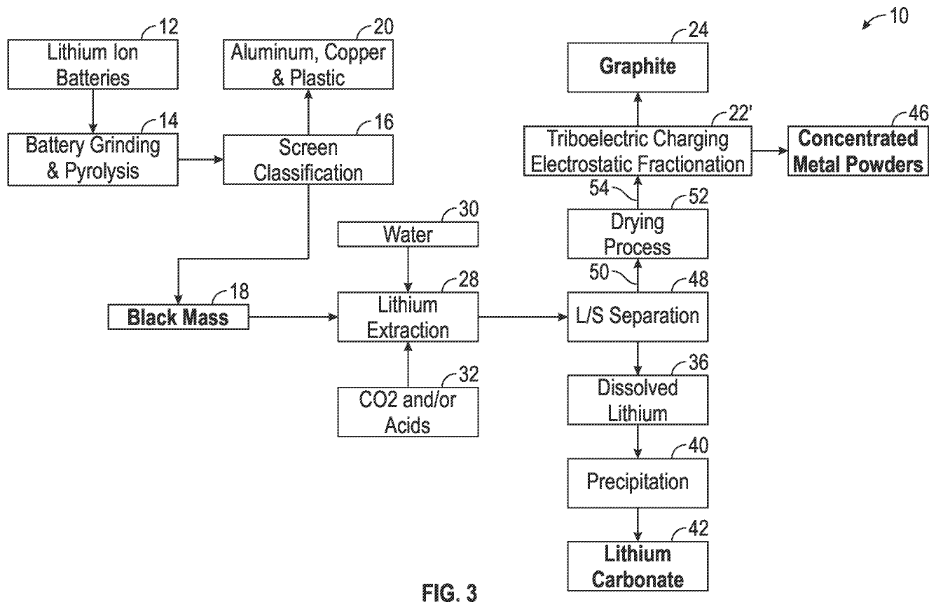

In another embodiment, and as illustrated in FIG. 3, lithium can be extracted directly from the black mass 18 in lithium extraction step 28 using the same methods as discussed above for lithium extraction from the grey mass. In this embodiment, lithium extraction 28 produces a lithium-depleted black mass 50 and a liquid comprising dissolved lithium 36. The lithium-depleted black mass 50 can be separated from the liquid containing dissolved lithium 36 in a solid/liquid separation step 48. This step can be accomplished by various methods including, but not limited to, decanting, centrifugal separation, or various means of filtering. The liquid fraction 36 comprising dissolved lithium is sent to a precipitation step 40. In one embodiment, the lithium is precipitated as lithium carbonate 42 by evaporation; however, other precipitation methods can be employed.

The lithium-depleted black mass 50 is dried in a drying process 52 to produce dry lithium-depleted back mass 54 which is then treated by triboelectric charging and electrostatic fractionation 22′ to separate the graphite from the metal powders. The resulting graphite product 24 and concentrated metal powder product 46 are the same or similar to the graphite product 24 and concentrated metal powder product 46 described above; however, the concentrated metal powder product 46 no longer requires a prior drying step as it has already been dried in drying process 52. The concentrated metal powder 46 has now had both lithium and graphite/carbon removed. This material can then be further processed by standard means of pyro or hydrometallurgical processes currently known.

### Example Experiments

Experiment 1—Lithium-Ion batteries were purchased and separated into three groups. The first group was left fully charged. The second group was discharged to approximately 50% and the third group was fully discharged. A battery from the fully discharged group was then cut. The resultant battery did not smoke nor get hot. Batteries from both the partial charged group and fully charged group were also cut and we saw significant expansion, heat and smoke generation. In addition, we saw “sparks” between layers of the batteries.

Experiment 2—A new set of partial and fully charged batteries were then tested wherein the batteries were cut in a nitrogen blanket environment. To our surprise, we saw no sparks, no smoke or heat being generated.

Experiment 3—The ground material from the ability experiments were then placed into a nitrogen blanketed oven at room temperature and ramped to a temperature of 550° C. Once temperature was reached the oven was turned off. After heating and cool down we saw that the electrolyte has depolymerized, vaporized and allowed easy removal of the powdered metals and graphite from the metallic layers. Any residual plastics from packaging were liquified.

Experiment 4—The material from Experiment 3 was then ground and screened into fine materials. The fine material was black mass and tested using ICP methods obtain data on the approximate percentages of the various powdered metals. Various separation tests were then attempted.

Experiment 5—The material from experiment 4 (Black mass) was mixed with 10 parts waters to 1 part of the black mass and blended. (250 g water: 25 g black mass). The admixture was then placed into a Parr reactor with CO2 gas to purge the system and pressurize the system to 200 psi. The Par reactor was then heated to a temperature of 250° C. degrees and a pressure of 2000 psi creating a supercritical CO2 state. The material was held at that state for approximately 120 minutes. Upon cool down and opening of the reactor chamber, we filtered out the solids from the liquid. The liquid was then placed on a hot plate to start evaporating the water which precipitated the lithium into white crystalline looking material. The material was then placed into an oven to finish drying into a fine powder material representing approximately 1-2% of the specific black mass sample weight.

Experiment 6—Triboelectric Charge & Electrostatic separation—Black mass from a Tesla battery was produced using nitrogen blanket shredding and nitrogen environment baking at a temperature of 150° C. to vaporize and disable the electrolyte portion. The remaining material was screened using a 60-mesh screen and the fines were a black mass material comprising approximately 54% carbon/graphite, 33% nickel, less than 1% aluminum, 5% cobalt and approximately 5.5% lithium. An acrylic sheet was triboelectrically charged by adhering a different plastic film with a weak glue and quickly peeled from the acrylic sheet to charge the surface. The acrylic sheet was then placed at a distance of ¼″ above the leveled black mass and we could see the graphite/carbon “jump” off of the table and adhere to the acrylic sheet. The material adhered to the acrylic was weighted and represented approximately 50% of the total black mass weight. The remaining metal powder fraction was named “grey mass”.

Various modifications and variations can be made in the present disclosure without departing from the spirit or scope of the disclosure.

From the foregoing, it will be seen that this disclosure is one well adapted to obtain all the ends and objects herein set forth, together with other advantages which are obvious and which are inherent to the structure.

It will be understood that certain features and sub combinations are of utility and may be employed without reference to other features and sub combinations. This is contemplated by and is within the scope of the claims.

As many possible embodiments may be made of the disclosure without departing from the scope thereof, it is to be understood that all matter herein set forth or shown in the accompanying drawings is to be interpreted as illustrative and not in a limiting sense.

While the foregoing written description of the disclosure enables one of ordinary skill to make and use what is considered presently to be the best mode thereof, those of ordinary skill will understand and appreciate the existence of variations, combinations, and equivalents of the specific exemplary embodiments and methods herein. The disclosure should therefore not be limited by the above-described embodiments and methods, but by all embodiments and methods within the scope and spirit of the disclosure as claimed.

What is claimed is:

1. A method for recycling lithium-ion batteries, the lithium-ion batteries comprising plastics, electrolyte, carbon, metals, and lithium; the method comprising:
a) grinding the lithium-ion batteries to form ground battery material;
b) pyrolyzing the ground battery material at a temperature between about 100° C. and 700° C. for a time sufficient to vaporize about 80 wt % to 100 wt % of electrolyte present in the ground battery material;
c) further grinding and screen classifying the pyrolyzed ground battery material to produce a screen oversize and a screen undersize, the screen oversize comprising metals and plastics, the screen undersize comprising a black mass material;
d) lithium dissolution, triboelectric charging and electrostatic separation of the black mass material to produce a liquid comprising dissolved lithium, a graphite product, and a metal fines product; and
e) precipitating lithium from the liquid comprising dissolved lithium.

2. The method of claim 1, wherein the step of grinding lithium-ion batteries is performed in an inert atmosphere and comprises a unit operation selected from the group consisting of shearing, puncturing, grinding, shredding, tearing, and combinations thereof.

3. The method of claim 2, wherein the inert atmosphere is provided by an inert gas selected from the group consisting of nitrogen, argon, carbon dioxide, one or more noble gases, and combinations thereof.

4. The method of claim 1, wherein the baked ground battery material is further baked to depolymerize or vaporize adhesives and plastics in the ground battery material.

5. The method of claim 1, wherein the vaporized electrolyte is recovered by condensation.

6. The method of claim 1, wherein the screen oversize comprises aluminum, copper, and plastics.

7. The method of claim 6, further comprising the steps of recovering plastics from the screen oversize, and converting the plastics into liquid fuel.

8. The method of claim 1, wherein lithium is first dissolved from the black mass material to produce a lithium-depleted black mass and a liquid comprising dissolved lithium, and the lithium-depleted black mass is dried, triboelectrically charged and electrostatically separated to produce the graphite product and the metal fines product.

9. The method of claim 1, wherein the black mass material is first triboelectrically charged and electrostatically separated to produce a graphite product and a grey mass comprising lithium and metal fines, and then lithium is dissolved from the grey mass to produce a metal fines product comprising grey mass, and a liquid comprising dissolved lithium.

10. The method of claim 1, wherein the triboelectric charging and electrostatic separation is accomplished using a charged transverse belt system.

11. The method of claim 1, wherein the lithium dissolution step uses a dissolving agent selected from the group consisting of water, CO₂, salt, alcohol, acid, and combinations thereof.

12. The method of claim 1, wherein the lithium dissolution step is operated, at least in part, under supercritical conditions.

13. The method of claim 12, wherein the lithium dissolution step utilizes supercritical CO₂.

14. The method of claim 12, wherein the step of dissolving lithium from the grey mass utilizes supercritical water.

15. The method of claim 1, wherein the lithium dissolution step is operated, at least in part, under subcritical conditions.

16. The method of claim 1, further comprising a solid/liquid separation step to recover the liquid comprising dissolved lithium.

17. The method of claim 16, wherein the solids/liquids separation step comprises a method selected from the group consisting of gravity phase separation, filtering, centrifugation, and combinations thereof.

18. The method of claim 1, further comprising the step of hydrometallurgical or pyrometallurgical processing of the metal fines product to separate individual metals present in the metal fines.

19. The metal fines produced as in the method of claim 1.

20. A method for recycling lithium-ion batteries, the lithium-ion batteries comprising plastics, electrolyte, carbon, metals, and lithium; the method comprising:
a) grinding the lithium-ion batteries in an inert nitrogen atmosphere to form ground battery material;
b) pyrolyzing the ground battery material at a temperature between about 100° C. and 700° C. for a time sufficient to vaporize about 80 wt % to 100 wt % of electrolyte present in the ground battery material;
c) further grinding and screen classifying the pyrolyzed ground battery material to produce a screen oversize and a screen undersize, the screen oversize comprising metals and plastics, the screen undersize comprising a black mass material; and
d) storing the black mass material for further treatment.

21. A method for processing back mass material derived from lithium-ion batteries as in claim 20, the method comprising:
dissolving lithium from the black mass material to produce a liquid comprising dissolved lithium, and a solid residue comprising graphite and metal fines;
solid/liquid separation and drying of the solid residue;
triboelectric charging and electrostatic separation of the dried solid residue to produce a graphite product and a metal fines product; and
precipitation of lithium from the liquid comprising dissolved lithium.

22. A method for processing back mass material derived from lithium-ion batteries as in claim 20, the method comprising:
triboelectric charging and electrostatic separation of the black mass material to produce a graphite product and a grey mass comprising lithium and metal fines;
dissolution of lithium from the grey mass followed by solid/liquid separation to produce a metal fines product and a liquid comprising dissolved lithium;
precipitation of the dissolved lithium from the liquid comprising dissolved lithium.
